(19) United States
(12) Patent Application Publication
(10) Pub. No.: US 2025/0280437 A1
(43) Pub. Date: Sep. 4, 2025

(54) METHOD AND APPARATUS FOR DETERMINING A SENSING BEAM ASSOCIATED WITH A PLURALITY OF COMMUNICATION TARGET DEVICES

(71) Applicant: Lenovo (Singapore) Pte. Limited, Singapore (SG)

(72) Inventors: Karthikeyan Ganesan, Kronberg Im Taunus (DE); Ravi Kuchibhotla, Chicago, IL (US)

(73) Assignee: Lenovo (Singapore) Pte. Limited, Singapore (SG)

(21) Appl. No.: 18/858,498

(22) PCT Filed: Apr. 21, 2023
(86) PCT No.: PCT/IB2023/054105

§ 371 Date: Oct. 21, 2024

Related U.S. Application Data
(60) Provisional application No. 63/333,397, filed on Apr. 21, 2022.

(51) Int. Cl. H04W 74/0808; H04W 16/14

(52) U.S. Cl. CPC H04W 74/0808; H04W 16/14

(57) ABSTRACT

A method and apparatus are provided, in which a plurality of L2 destination identifiers associated with a plurality of communication target devices are identified, and a plurality of transmission beams respectively associated with each of the identified plurality of L2 destination identifiers are identified (202). A sensing beam, which includes the plurality of transmission beams is determined (204). An assessment is performed (206) of a channel associated with the sensing beam, A channel occupancy for the user equipment is initiated (208), when a result of the assessment of the channel associated with the sensing beam determines that the channel associated with the sensing beam is clear. The communication target devices, via a transmission, are communicated with, the communication target devices being associated with the L2 destination identifiers that correspond to the transmission beams included in the sensing beam, which was determined as being clear (210).

### FIELD OF THE INVENTION

The present disclosure is directed to the determination of a sensing beam for identifying channel occupancy relative to a plurality of communication targets, and more particularly to the determination of a sensing beam that encompasses the transmission beams associated with a plurality of prioritized communication targets, which can be used in support of a sidelink transmission.

### BACKGROUND OF THE INVENTION

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology (NR), Long Term Evolution (LTE), Universal Mobile Telecommunications Service (UMTS), Global System for Mobile Communication (GSM), and/or Enhanced Data GSM Environment (EDGE).

As part of functioning within the network various operational parameters of the device may need to be managed in order for the device to more efficiently operate as intended, while allowing for information to be shared between the device and the network, and while also helping to better balance the desired performance of the device with the potential negative impact on other devices operating within the shared environment of the network.

In an effort to enhance system performance, more recent standards have looked at different forms of multiplexing including time domain and spatial domain multiplexing. The spatial domain multiplexing can involve spatial diversity including different forms of multiple input multiple output (MIMO) systems, which can make use of multiple antennas at each of the source and the destination of the wireless communication for multiplying the capacity of the radio link through the use of directional beams and/or multipath propagation corresponding to respective spatial information. Such a system makes increasingly possible the simultaneous transmission and reception of more than one data signal using the same radio channel space. This can also be the case for peer-to-peer communications in an unlicensed portion of the spectrum.

Communications in an unlicensed portion of the spectrum can sometimes involve a form of communication referred to as listen before talk (LBT). In LBT, a radio transmitter will often sense the radio environment for activity from other sources in the radio channel space of interest (listen), before attempting to transmit (talk), after the radio channel space is determined to be relatively clear of other already existing communications. In instances where a single communication target is defined, an identification of the channel space between the source and the target can be relatively straight forward, even in instances involving the use of spatial domain multiplexing.

The present inventors have recognized that in some instances it may be desirable to communicate with multiple communication targets. In such an instance it would be beneficial if the sensing of the radio environment could be adjusted to account for a sensing of the environment that allows for a determination of a clear channel that could account for the potential for multiple communication targets. It would also be beneficial if during the sensing of the radio environment, a prioritization of the multiple targets for purposes of sensing of the radio environment could be adjusted based upon a cast type of communication, such as whether the communication is intended to be used as part of a unicast, a groupcast, or a broadcast.

### SUMMARY

The present application provides a method in a user equipment. The method includes identifying a plurality of L2 destination identifiers associated with a plurality of communication target devices, and identifying a plurality of transmission beams respectively associated with each of the identified plurality of L2 destination identifiers. A sensing beam, which includes the plurality of transmission beams corresponding to the communication target devices, is determined. An assessment is performed of a channel associated with the sensing beam. A channel occupancy for the user equipment is initiated, when a result of the assessment of the channel associated with the sensing beam determines that the channel associated with the sensing beam is clear. The communication target devices, via a transmission, are communicated with, the communication target devices being associated with the L2 destination identifiers that correspond to the associated respective transmission beams included in the sensing beam, which was determined as being clear.

According to another possible embodiment, a user equipment for peer to peer communication with a plurality of communication targets is provided. The user equipment includes a transceiver. The user equipment further includes a controller for identifying a plurality of L2 destination identifiers associated with the plurality of communication target devices, and identifying a plurality of transmission beams respectively associated with each of the identified plurality of L2 destination identifiers. The controller further determines a sensing beam, which includes the plurality of transmission beams corresponding to the communication target devices, and the controller via the transceiver performs an assessment of a channel associated with the sensing beam. A channel occupancy for the user equipment is initiated by the controller via the transceiver, when a result of the assessment of the channel associated with the sensing beam determines that the channel associated with the sensing beam is clear. The transceiver communicates with the communication target devices via a transmission, the communication target devices being associated with the L2 destination identifiers that correspond to the associated respective transmission beams included in the sensing beam, which was determined as being clear.

These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is a flow diagram in a user equipment for the determination of a sensing beam for identifying channel occupancy relative to a plurality of communication target devices; and

FIG. 3 is an example block diagram of an apparatus according to a possible embodiment.

### DETAILED DESCRIPTION OF THE PREFERRED EMBODIMENT(S)

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide support for the determination of a sensing beam for identifying channel occupancy relative to a plurality of communication target devices.

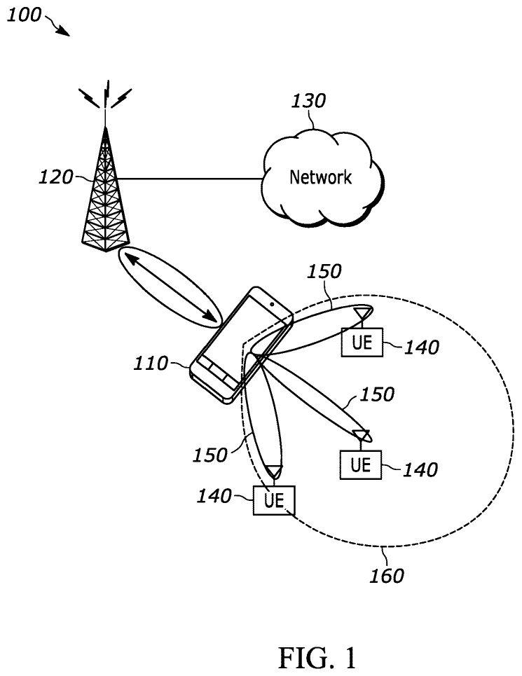

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130.

The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In addition to and/or alternative to communicating with the network 130, the wireless communication device 110 can communicate more directly with other wireless communication devices, such as user equipment 140. An example of this type of communication can sometimes be called peer-to-peer. In this example, the base station 120 and the other user equipment 140 are potential communication targets of the wireless communication device 110. Further, the wireless communication device can communicate with each of the communication targets via a distinct respective transmission beam, which can have a corresponding direction as well as a corresponding beam width. In the illustrated example, a respective exemplary beam 150 is associated with each of other user equipment 140.

Still further, it may be possible, in some instances, to define a beam that can encompass multiple ones of the transmission beams. An example of such a beam could correspond to beam 160, which would similarly have a direction, as well as a corresponding beam width. In many instances, the beam width would need to be increased in order to span an area that can encompass multiple potential communication targets that are geographically dispersed. By using such a beam, it may be possible to communicate individually with each of the illustrated other user equipment 140, either individually, as part of a unicast type communication, or together as part of a broadcast or multi-cast type communication. While beam 160 is sized and shaped to encompass a spatially defined region capable of supporting the establishment of a communication with each of the illustrated other user equipment 140, the beam is directed away from the base station 120. Correspondingly, the beam 160 could not be used for purposes of alternatively or simultaneously supporting the establishment of a communication with the base station 120. However, one skilled in the art will appreciate that dependent upon the relative positions of the other user equipment 140, and the base station 120, it is theoretically possible that a beam could alternatively be defined that could encompass various alternative combinations of the potential communication targets.

Sidelink operation in unlicensed spectrum and frequency range (FR) 2/FR2.2 are getting more attention for commercial deployment such as extended reality (XR) devices where support for higher data rates may be necessary.

In the present application, spatial listen before talk (LBT)/directional LBT when beam-based transmission/reception is expected for unlicensed operation in high frequency range such as beyond 52.6 GHz are discussed. In release 17, new radio unlicensed (NR-U) standardized some of the channel access procedure for spatial LBT/directional LBT. However, in the present application, solutions are provided on how to handle the relationship between sensing beam and transmission for sidelink in a channel occupancy for sidelink spatial listen before talk (LBT)/directional LBT when beam-based transmission/reception is expected for unlicensed operation in high frequency range, including considering transmissions/reception on different beams within the remaining channel occupancy time (COT) to different source/destination identification (id) and cast types.

When a gNB/UE(s) is required by regulations to sense channel(s) for availability for performing transmission(s) on the channel(s) or when a gNB provides UE(s) with higher layer parameters LBT-Mode by system information block (SIB) 1 or dedicated configuration indicating that the channel access procedures would be performed for performing transmission(s) on channel(s), the channel access procedures described in this clause for accessing the channel(s) on which the transmission(s) are performed by the gNB/UE(s), are applied.

In this clause, when sensing is applicable, the basic unit to perform sensing is a sensing slot with a duration Tₛₗ=5 μs. The channel is considered to be idle for the sensing slot duration Tₛₗ if a gNB or a UE senses the channel during the sensing slot duration and determines that the detected energy after the antenna assembly within the sensing slot duration is less than energy detection threshold X_{Thresh} as described in Clause 4.4.7. Otherwise, the channel is considered busy for the sensing slot duration Tₛₗ.

The spatial domain filter for sensing beam(s) during the sensing slot duration at the gNB, or at a UE when the UE does not indicate a capability for beam correspondence without the uplink beam sweeping, or at a UE when the UE uses a different beam for sensing than the beam used for transmission, covers the transmission beam(s) of the intended transmission(s) within the channel occupancy.

If a UE indicates a capability for beam correspondence without the uplink beam sweeping and if the UE selects the same sensing beam(s) as the transmission beam(s), the spatial domain filter for sensing beam is determined as described in Clause 5.1.5 of the 3rd Generation Partnership Project (3GPP) Technical Specification (TS) 38.214, entitled “NR; Physical layer procedures for data”.

If a channel occupancy includes transmission(s) in different beams that are multiplexed in spatial domain, one of the followings is generally applicable for the corresponding sensing to perform the transmission(s) within the channel occupancy:
Type 1 channel access procedure as described in Clause 4.4.1 is applied before the start of the channel occupancy using a single sensing beam where the single beam covers all the transmission beams within the channel occupancy. When the channel is accessed the transmission(s) within the channel occupancy across different beams can occur.
Type 1 channel access procedure as described in Clause 4.4.1 is applied before the start of the channel occupancy simultaneously per sensing beam where each sensing beam covers a transmission beam within the channel occupancy. When the channel is accessed the transmission(s) within the channel occupancy across different beams can occur.

If a channel occupancy includes transmissions in different beams that are multiplexed in time domain, one of the followings is applicable for the corresponding sensing to perform the transmissions within the channel occupancy:
Type 1 channel access procedure as described in Clause 4.4.1 is applied before the start of the channel occupancy using a single sensing beam where the single beam covers all the transmissions beams within the channel occupancy. When the channel is accessed the transmissions within the channel occupancy across different beams can occur following the procedures described in Clause 4.4.3.
When the gNB/UE can perform simultaneous sensing in different beams, Type 1 channel access procedure as described in Clause 4.4.1 is applied before the start of the channel occupancy per sensing beam where each sensing beam covers a transmission beam within the channel occupancy. When the channel is accessed the transmission within the channel occupancy across different beams can occur following the procedures described in Clause 4.4.3.

When the gNB/UE can perform simultaneous sensing in different beams, Type 1 channel access procedure as described in Clause 4.4.1 is applied before the start of the channel occupancy per sensing beam where each sensing beam covers a transmission beam within the channel occupancy. When the channel is accessed the transmission within the channel occupancy can occur following the procedures in Clause 4.4.2 before switching to a different beam within the channel occupancy.

### Type 1 Channel Access Procedures

This clause describes channel access procedures to be performed by a gNB/UE where the time duration spanned by the sensing slots that are sensed to be idle before a transmission(s) is random based on a fixed contention window size. The clause is applicable to any transmission initiating a channel occupancy by the gNB/UE.

The gNB/UE may transmit a transmission after first sensing the channel to be idle during the sensing slot duration of a defer duration T_{d} and after the counter N is zero in step 4. The counter N is adjusted by sensing the channel for additional sensing slot duration(s) according to the steps below:
1) set N=Nᵢₙᵢₜ, where Nᵢₙᵢₜ is a random number uniformly distributed between 0 and CW, and go to step 4;
2) if N>0 and the gNB/UE chooses to decrement the counter, set N=N−1;
3) sense the channel for an additional sensing slot duration, and if the channel is idle for the additional sensing slot duration, go to step 4; else, go to step 5;
4) if N=0, stop; else, go to step 2.
5) sense the channel until either it is detected busy within an additional defer duration T_{d} or it is detected to be idle for the sensing slot of the additional defer duration T_{d};
6) if the channel is sensed to be idle during the sensing slot duration of the additional defer duration T_{d}, go to step 4; else, go to step 5;

In the above procedures, CW is the contention window and CW=3.

The defer duration is T_{d}=8 μs and includes a sensing slot duration Tₛₗ=5 μs for performing as least a single measurement to determine whether the channel is idle.

A gNB/UE shall not transmit on a channel for a Channel Occupancy Time that exceeds 5 ms.

### Type 2 Channel Access Procedures

This clause describes channel access procedures to be performed by a gNB/UE where the time duration spanned by sensing slots that are sensed to be idle before a DL/UL transmission(s) is deterministic.

A gNB/UE may transmit a transmission(s) on a channel immediately after T_{d} which includes a sensing slot with a duration T_{sd}=5 82 s where the channel is sensed to be idle.

### Type 3 Channel Access Procedures

A gNB/UE may transmit a transmission on a channel without sensing the channel.

3rd Generation Partnership Project (3GPP) Technical Specification (TS) 38.321 provides as follows:

### Section 5.22.1.4.1.2 Selection of Logical Channels

The medium access control (MAC) entity shall for each sidelink control information (SCI) corresponding to a new transmission:
1>select a Destination associated to one of unicast, groupcast and broadcast, that is in the sidelink (SL) active time for the SL transmission occasion if SL discontinuous reception (DRX) is applied for the destination, and having at least one of the MAC control element (CE) and the logical channel with the highest priority, among the logical channels that satisfy all the following conditions and MAC CE(s), if any, for the SL grant associated to the SCI:
   2>SL data is available for transmission; and
   2>SBj>0, in case there is any logical channel having SBj>0; and
   2>sl-configuredGrantType1Allowed, if configured, is set to true in case the SL grant is a Configured Grant Type 1; and
   2>sl-AllowedCG-List, if configured, includes the configured grant index associated to the SL grant; and
   2>sl-HARQ-FeedbackEnabled is set to disabled, if physical sidelink feedback channel (PSFCH) is not configured for the SL grant associated to the SCI.

NOTE 1: If multiple Destinations have the logical channels satisfying all conditions above with the same highest priority or if multiple Destinations have either the MAC CE and/or the logical channels satisfying all conditions above with the same priority as the MAC CE, which Destination is selected among them is up to UE implementation.
1>select the logical channels satisfying all the following conditions among the logical channels belonging to the selected Destination:
   2>SL data is available for transmission; and
   2>sl-configuredGrantType1Allowed, if configured, is set to true in case the SL grant is a Configured Grant Type 1; and.
   2>sl-AllowedCG-List, if configured, includes the configured grant index associated to the SL grant; and
      3>if PSFCH is configured for the sidelink grant associated to the SCI:
         4>sl-HARQ-FeedbackEnabled is set to enabled, if sl-HARQ-FeedbackEnabled is set to enabled for the highest priority logical channel satisfying the above conditions; or
         4>sl-HARQ-FeedbackEnabled is set to disabled, if sl-HARQ-FeedbackEnabled is set to disabled for the highest priority logical channel satisfying the above conditions.
      3>else:
         4>sl-HARQ-FeedbackEnabled is set to disabled.

NOTE 2: sl-HARQ-FeedbackEnabled is set to disabled for the transmission of a MAC protocol data unit (PDU) only carrying CSI reporting MAC CE or Sidelink DRX Command MAC CE or Sidelink Inter-UE Coordination Request MAC CE or Sidelink Inter-UE Coordination Information MAC CE.

In the present application, the following solutions are proposed:

When clear channel assessment is done in a directional manner using a single sensing beam, the single sensing beam covers the transmission beams within the channel occupancy. When the channel access is successful, the transmission(s) within the channel occupancy across different beams time division multiplexing (TDM)/spatial division multiplexing (SDM) can occur to different source/destination pairs served by the transmission beam. A new logical channel prioritization (LCP) procedure prioritizes the L2 source/destination id(s) that may be served by these transmission beams.

A table containing mapping information between sensing and transmission beams for different cast types may be preconfigured in a resource pool or semi-statically signaled using UE dedicated signaling.

### Embodiment 1

According to embodiment 1, when a transmitting device is scheduled to transmit in an unlicensed band, then it is expected to initiate channel occupancy based on successful clear channel assessment procedure using a sensing beam, the sensing beam may be quasi omni-directional or directional i.e., wider/narrower selected to cover plurality of L2 destination id(s) using plurality of corresponding transmission beam(s) using TDM or SDM within the channel occupancy. In this embodiment, the UE may prioritize those layer 2 (L2) source and/or L2 destination id(s) whose transmission beam(s) could be covered by the sensing beam within channel occupancy. Prioritization of L2 source and/or L2 destination id(s) may be performed by logical channel prioritization procedure as part of the first step in the destination selection.

When the UE receives a SL grant (SL DCI) it considers all SL logical channels (LCHs) and cast types as valid candidates for L2 destination id selection, for which the corresponding transmission beams could be covered by a sensing beam which initiated the channel. The highest priority logical channel corresponding to the selected L2 destination maybe chosen for transmission.

When the UE performs simultaneous clear channel assessment per sensing beam where each sensing beam covers a transmission beam within the channel occupancy, the UE may prioritize the L2 destination id(s) and then the highest priority SL LCH(s) corresponding to the L2 destination ids served by the transmission beam corresponding to the sensing beam(s), where the clear channel assessment was successful.

There could be a mapping table between the transmission/reception beam(s) and L2 source-L2 destination id(s), which may be periodically updated within the UE based on beam measurement report. Such a mapping table may be reported from the physical (PHY) layer to the medium access control (MAC) layer, such that the MAC selects the corresponding L2 source-L2 destination id(s) based on the availability of the sidelink resource, transmission beam corresponding to the sensing where the clear channel assessment was successful.

In one implementation, there could be a mapping between a sensing beam and plurality of transmission beam which may be specified and signaled based on, spatial domain filter using quasi co-location type-D, beam angle, beam gain, effective isotropic radiated power, or a combination thereof. The mapping information may be preconfigured in a resource pool and could even be preconfigured separately for each of unicast, groupcast/broadcast type of communication otherwise signaled to the UE using dedicated RRC signaling.

The UE may initiate the clear channel assessment when it has data waiting in its buffer(s) which may belong to a L2 destination id(s), and UE after knowing the transmission beam corresponding to L2 destination(s) may choose a suitable sensing beam to be selected for performing the clear channel assessment procedure. Sidelink sensing, transmission and reception in the unlicensed spectrum using beamforming may be performed with a distributed multiple antenna technique for vehicular user equipment or a co-located multiple antenna technique for handheld devices.

The UE may select the L2 destination id(s) and highest priority logical channel for transmission, select the corresponding transmission beams and then select the sensing beam associated with those transmission beams.

A transmit (Tx) UE after performing clear channel assessment using a sensing beam may share COT within the remaining channel occupancy, the receive (Rx) UE may not know the angle of the sensing beam width to select the transmission beam, hence the Tx UE may include the sensing beam width, angle, EIRP etc., in the physical channel or in the higher layer signaling to the Rx UEs. In another implementation, the Rx UE may select the transmission beam according to the receive beam receiving the physical sidelink control channel (PSCCH), the physical sidelink shared channel (PSSCH), the COT sharing indicator etc., from the corresponding Tx UE. The SCI carrying the COT sharing indicator could be restricted to a certain cast type, and in one implementation the cast type field in the SCI may inform the COT recipient about the cast type of the COT sharing indicator. For example, COT initiator UE (Tx UE) may share the initiate COT with another peer UE using a unicast type. COT initiator UE (Tx UE) may share the initiate COT with a group of UEs using a groupcast type. The SCI carrying COT indicator might also indicate the destination id for which the COT sharing indicator could be applicable.

### Embodiment 2

According to the second embodiment, when clear channel assessment is done in a directional manner using a single sensing beam, the single beam covers the transmission beams within the channel occupancy. When the channel is accessed, the transmission(s) within the channel occupancy across different beams can occur to different source/destination pairs served by the transmission beam. A new LCP procedure prioritizes the cast type and the L2 source/destination id(s) that may be served by these transmission beams. There could be a mapping between the sensing beam and the cast type i.e., groupcast, unicast, broadcast. Depending on the cast type of the data to be transmitted, a certain sensing beam may be chosen and the selection of the cast type for transmission using one or more transmission beams to be used can be prioritized in the LCP procedure.

For example, a selection of sensing beam used for unicast transmission using a narrow beam width or spatial filter in terms of QCL type D relationship in the direction of a peer Rx UE may restrict the transmission to a unicast data. However groupcast data may be transmitted using a beam sweeping manner provided that one or more transmission beams used for the groupcast transmission falls within the selected sensing beam. Similarly, the sensing beam selected for wider groupcast transmission may serve both the transmission of both unicast and groupcast data.

In one implementation such a mapping may include angle of the sensing beam width corresponding to each cast type which could be preconfigured per resource pool or signaled using UE dedicated signaling.

In another implementation, the sensing beam gain, measured along the direction of peak transmission direction, is at least a predefined value X dB of the transmission beam gain, which may be provided for each cast type.

In another implementation, the sensing beam gain is measured in one or more directions where the transmission beam EIRP is within a predefined value Y dB of the peak EIRP, which may be provided for each cast type. The sensing beam gain measured along the chosen directions is at least X dB of the transmission beam gain in those directions, and may be provided for each cast type.

In another implementation, the sensing beam gain is measured in one or more directions where the transmission beam EIRP is within a predefined value A dB of the peak EIRP, and may be provided for each cast type and the sensing beam gain measured along the chosen directions is at least X [FFS] dB of the peak sensing beam gain, and may be provided for each cast type.

In another implementation, the sensing beam has the minimum X dB beamwidth which at least contains all beam peak directions of transmission beams, and may be provided for each cast type.

In another implementation, the spatial filter i.e., QCL type-D used for the sensing beam may be shared in the transmission beam towards Rx UE(s) as part of the COT sharing.

When clear channel assessment is done in a directional manner using a single sensing beam, the single beam can cover all the transmission beams within the channel occupancy. When the channel is accessed, the transmission(s) within the channel occupancy across different beams can occur to different source/destination pairs served by the transmission beam. A new LCP procedure prioritizes the L2 source/destination id(s) that may be served by these transmission beams.

A table containing mapping information between sensing and transmission beams for different cast types may be preconfigured in a resource pool or semi-statically signaled using UE dedicated signaling.

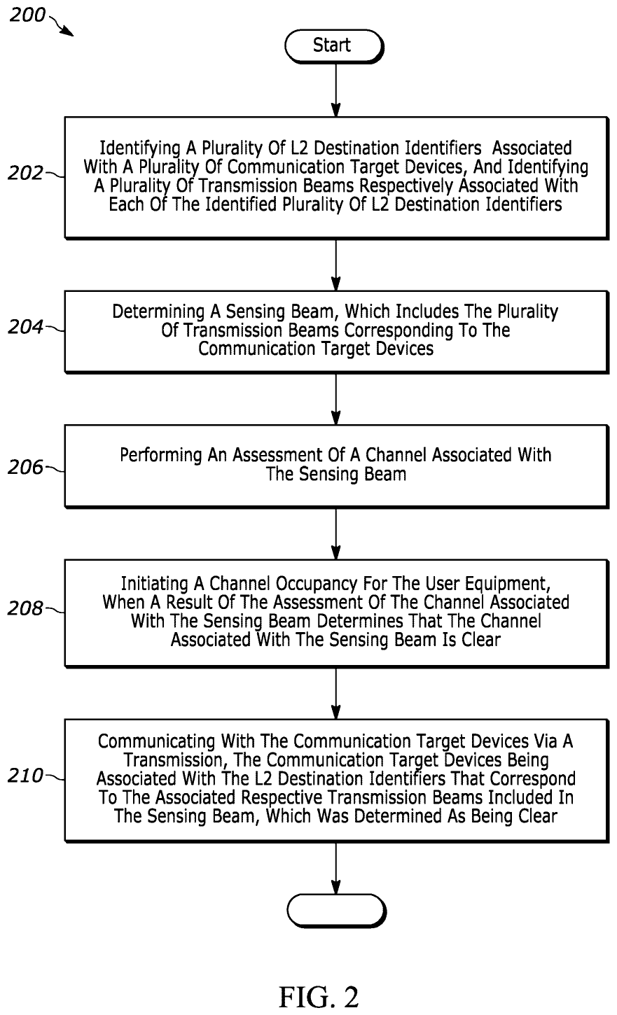

FIG. 2 illustrates a flow diagram 200 of a method in a user equipment. The method includes identifying a plurality of L2 destination identifiers associated with a plurality of communication target devices, and identifying a plurality of transmission beams respectively associated with each of the identified plurality of L2 destination identifiers 202. A sensing beam, which includes the plurality of transmission beams corresponding to the communication target devices, is determined 204. An assessment is performed 206 of a channel associated with the sensing beam. A channel occupancy for the user equipment is initiated 208, when a result of the assessment of the channel associated with the sensing beam determines that the channel associated with the sensing beam is clear. The communication target devices, via a transmission, are communicated 210 with, the communication target devices being associated with the L2 destination identifiers that correspond to the associated respective transmission beams included in the sensing beam, which was determined as being clear.

In some instances, the plurality of communication target devices can correspond to a set of devices, where in some of the same or other instances the communication target devices can correspond to communication targets of interest.

In some instances, the channel associated with the sensing beam for which the assessment is being performed can include a channel associated with a sidelink operation in an unlicensed spectrum. In some of these instances, sidelink sensing, transmission and reception in the unlicensed spectrum using beamforming can be performed with a distributed multiple antenna technique for vehicular user equipment or a co-located multiple antenna technique for handheld devices.

In some instances, the channel associated with the sensing beam is determined to be clear, when an energy associated with the channel is detected using the sensing beam during a sensing slot duration, and the detected energy satisfies an energy detection threshold. As an example, determining that the detected energy satisfies an energy detection threshold can include where the detected energy is less than the threshold.

In some instances, each of the sensing and transmission beams can correspond to a spatial domain filter using quasi co-location type-D, beam angle, beam gain, effective isotropic radiated power, or a combination thereof.

In some instances, the sensing beam can be determined, so as to include at least a particular prioritized one of the transmission beams associated with a communication target device. In some of these instances, the particular prioritized one of the transmission beams can be dependent on a cast type of communication.

In some instances, the plurality of transmission beams can each be associated with a selected one of multiple cast types of communication. In some of these instances, the multiple cast types of communication can include one or more of unicast, groupcast, or broadcast.

In some instances, the plurality of transmission beams can include different beams that are multiplexed in a spatial domain.

In some instances, the plurality of transmission beams can include different beams that are multiplexed in a time domain.

In some instances, determining the sensing beam, which includes the plurality of transmission beams corresponding to the communication target devices, can comprise accessing a table that maps information between sensing beams and transmission beams. In some of these instances, the table containing mapping information between sensing beams and transmission beams can be determined for different cast types of communication, a type of antenna placement which is distributed using a multiple antenna technique for vehicular user equipment, a co-located multiple antenna technique for handheld devices, or a combination there of. In some instances, the contents of the table can be preconfigured in a resource pool. In other of these instances, the contents of the table can be signaled using user equipment dedicated signaling. Further, the content of mapping information between sensing beams and transmission beams could be indicated using quasi co-location type-D, beam angle, beam gain, effective isotropic radiated power, or a combination thereof.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

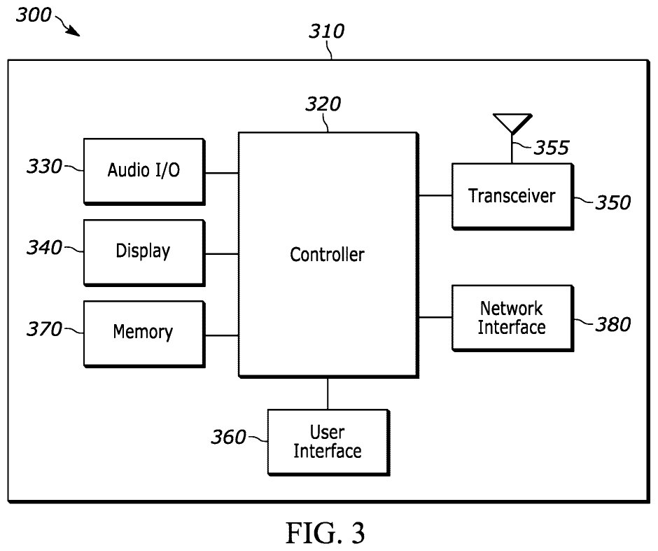

FIG. 3 is an example block diagram of an apparatus 300, such as the wireless communication device 110, according to a possible embodiment. The apparatus 300 can include a housing 310, a controller 320 within the housing 310, audio input and output circuitry 330 coupled to the controller 320, a display 340 coupled to the controller 320, a transceiver 350 coupled to the controller 320, an antenna 355 coupled to the transceiver 350, a user interface 360 coupled to the controller 320, a memory 370 coupled to the controller 320, and a network interface 380 coupled to the controller 320. The apparatus 300 can perform the methods described in all the embodiments.

The display 340 can be a viewfinder, a liquid crystal display (LCD), a light emitting diode (LED) display, a plasma display, a projection display, a touch screen, or any other device that displays information. The transceiver 350 can include a transmitter and/or a receiver. The audio input and output circuitry 330 can include a microphone, a speaker, a transducer, or any other audio input and output circuitry. The user interface 360 can include a keypad, a keyboard, buttons, a touch pad, a joystick, a touch screen display, another additional display, or any other device useful for providing an interface between a user and an electronic device. The network interface 380 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 370 can include a random access memory, a read only memory, an optical memory, a solid state memory, a flash memory, a removable memory, a hard drive, a cache, or any other memory that can be coupled to an apparatus.

The apparatus 300 or the controller 320 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a.NET® framework, or any other application framework. The software and/or the operating system may be stored in the memory 370 or elsewhere on the apparatus 300. The apparatus 300 or the controller 320 may also use hardware to implement disclosed operations. For example, the controller 320 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 320 may be any controller or processor device or devices capable of operating an apparatus and implementing the disclosed embodiments. Some or all of the additional elements of the apparatus 300 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, 5 or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

What is claimed is:

1-21. (canceled)

22. A user equipment (UE) for wireless communication, comprising:
at least one memory; and
at least one processor coupled with the at least one memory and configured to cause the UE to:
identify a plurality of Layer 2 (L2) destination identifiers associated with a plurality of target devices;
determine a sensing beam based at least in part on a plurality of transmission beams, wherein each L2 destination identifier is associated with a respective transmission beam of the plurality of transmission beams;
perform an assessment of a channel associated with the sensing beam;
initiate a channel occupancy for the UE based at least in part on a result of the assessment of the channel; and
communicate with the target devices based at least in part on the initiated channel occupancy, each of the target devices being associated with a respective L2 destination identifier and a respective transmission beam.

23. The UE of claim 22, wherein the channel associated with the sensing beam includes a channel associated with a sidelink operation in an unlicensed spectrum.

24. The UE of claim 23, wherein that at least one processor is configured to cause the UE to perform sidelink sensing, transmission, and reception in the unlicensed spectrum using beamforming with a distributed multiple antenna technique for vehicular user equipment or a co-located multiple antenna technique for handheld devices.

25. The UE of claim 22, wherein the channel associated with the sensing beam is determined to be clear based at least in part on an energy associated with the channel being detected using the sensing beam during a sensing slot duration, and the energy satisfying an energy detection threshold.

26. The UE of claim 22, wherein the sensing beam and the transmission beams correspond to a spatial domain filter using one or more of quasi co-location type-D, beam angle, beam gain, or effective isotropic radiated power.

27. The UE of claim 22, wherein the at least one processor is configured to cause the UE to determine the sensing beam to include at least a prioritized transmission beam of the transmission beams associated with a communication target device.

28. The UE of claim 27, wherein the prioritized transmission beam is based at least in part on a cast type of communication.

29. The UE of claim 22, wherein the plurality of transmission beams are each associated with a selected one of multiple cast types of communication.

30. The UE of claim 29, wherein the multiple cast types of communication include one or more of unicast, groupcast, or broadcast.

31. The UE of claim 22, wherein the plurality of transmission beams include different beams that are multiplexed in a spatial domain.

32. The UE of claim 22, wherein the plurality of transmission beams include different beams that are multiplexed in a time domain.

33. The UE of claim 22, wherein to determine the sensing beam, the at least one processor is configured to cause the UE to access a table that maps information between sensing beams and transmission beams.

34. The UE of claim 33, wherein the table is determined for one or more of different cast types of communication, a type of antenna placement which is distributed using a multiple antenna technique for vehicular user equipment, or a co-located multiple antenna technique for handheld devices.

35. The UE of claim 33, wherein contents of the table are preconfigured in a resource pool.

36. The UE of claim 33, wherein contents of the table are signaled using UE dedicated signaling.

37. The UE of claim 33, wherein the table comprises content of mapping information between sensing beams and transmission beams indicated using one or more of quasi co-location type-D, beam angle, beam gain, or effective isotropic radiated power.

38. A processor for wireless communication, comprising:
at least one controller coupled with at least one memory and configured to cause the processor to:
identify a plurality of Layer 2 (L2) destination identifiers associated with a plurality of target devices;
determine a sensing beam based at least in part on a plurality of transmission beams, wherein each L2 destination identifier is associated with a respective transmission beam of the plurality of transmission beams;
perform an assessment of a channel associated with the sensing beam;
initiate a channel occupancy for a user equipment (UE) based at least in part on a result of the assessment of the channel; and
communicate with the target devices based at least in part on the initiated channel occupancy, each of the target devices being associated with a respective L2 destination identifier and a respective transmission beam.

39. The processor of claim 38, wherein the channel associated with the sensing beam includes a channel associated with a sidelink operation in an unlicensed spectrum.

40. The processor of claim 39, wherein that at least one controller is configured to cause the processor to perform sidelink sensing, transmission, and reception in the unlicensed spectrum using beamforming with a distributed multiple antenna technique for vehicular user equipment or a co-located multiple antenna technique for handheld devices.

41. A method performed by a user equipment (UE), the method comprising:
identifying a plurality of Layer 2 (L2) destination identifiers associated with a plurality of target devices;
determining a sensing beam based at least in part on a plurality of transmission beams, wherein each L2 destination identifier is associated with a respective transmission beam of the plurality of transmission beams;
performing an assessment of a channel associated with the sensing beam;
initiating a channel occupancy for the UE based at least in part on a result of the assessment of the channel; and
communicating with the target devices based at least in part on the initiated channel occupancy, each of the target devices being associated with a respective L2 destination identifier and a respective transmission beam.
